(19) United States
(12) Patent Application Publication
(10) Pub. No.: US 2025/0341059 A1
(43) Pub. Date: Nov. 6, 2025

(54) EMBOSSED MULTI-PLY PAPER PRODUCTS AND METHODS FOR MAKING THE SAME

(71) Applicant: GPCP IP Holdings LLC, Atlanta, GA (US)

(72) Inventors: Dinesh M. Bhat, Neenah, WI (US); Michael D. Wishneski, Oconto, WI (US); Luke J. Van Den Plas, Green Bay, WI (US); Paul L. Bisso, Guyton, GA (US)

(21) Appl. No.: 18/869,297

(22) PCT Filed: May 29, 2023
(86) PCT No.: PCT/IB2023/055484

§ 371 Date: Nov. 26, 2024

Related U.S. Application Data
(60) Provisional application No. 63/347,151, filed on May 31, 2022.

(51) Int. Cl. D21H 27/30; A47K 10/16; B31F 1/07; B32B 3/10; B32B 7/12; B32B 29/00; D21H 27/00

(52) U.S. Cl. CPC D21H 27/30; A47K 10/16; B32B 3/10; B32B 7/12; B32B 29/005; D21H 27/007; B31F 1/07; B32B 2250/02; B32B 2307/718; B32B 2307/7376; B32B 2555/02

(57) ABSTRACT

Disclosed herein are embossed multi-ply paper products having a first ply comprising an emboss pattern with both microembossments and macroembossments and a second ply comprising an emboss pattern with only microembossments, wherein the first and second plies are joined together at the tips of the microembossments in a tip-to-tip configuration, as well as methods of making, embossing, joining, and converting such embossed paper products.

### RELATED APPLICATIONS

This application claims the benefit under 35 U.S.C. § 119(e) to U.S. Provisional Application No. 63/347,151 filed May 31, 2022, which application is incorporated by reference herein in its entirety.

### FIELD

Embossed multi-ply paper products, such as napkins, towels, tissues, and wipers are disclosed. More particularly, multi-ply paper products with improved characteristics such as caliper, absorbency, stack height, and/or aesthetics are disclosed, wherein a first ply comprises an emboss pattern with both microembossments and macroembossments, a second ply comprises an emboss pattern with only microembossments, and the first and second plies are joined together at the tips of the microembossments in a tip-to-tip configuration. Methods of making, embossing, joining, and converting such improved paper products are also described.

### BACKGROUND

Consumers' daily lives are filled with a variety of modern products that are produced solely for their comfort and convenience. Absorbent paper goods take a prominent place in the list of the most used modern conveniences. Typical paper products used by consumers daily include, for example, napkins, paper towels, toilet tissues, facial tissues, wipers, and the like. In the current market where high-end absorbent paper products demand premium prices, consumers are very particular about the products for which they will pay a premium price. Premium products must be strong and absorbent, but also thick, soft, and visually appealing.

Product attributes are imparted to paper products both during production of the cellulosic fibrous plies, as well as during converting operations such as embossing that are used to change the cellulosic fibrous plies into the final product. As embossing patterns have become commonplace in the production of premium products, both different methods of embossing, as well as different embossing patterns, have been developed with the goal to improve one or more product attributes. In many instances, the specific embossing method and/or pattern are chosen to create certain balanced characteristics in the final product. Attributes such as strength, stretch, caliper, absorbency, and aesthetics are often competing characteristics, with changes to embossing patterns and systems intended to improve one or more attributes having a deleterious effect on others. New embossing systems and patterns are thus still desired to obtain paper products with beneficial combinations of properties.

Microembossing is generally used to impart bulk to a paper ply, although it may also be used in the case where it may be desirable to impart an aesthetic design. Macroembossing is generally used to impart an aesthetic design to a paper ply, although it may also be used for plying and/or to increase bulk. U.S. Pat. No. 7,799,169 teaches a method of embossing a multi-ply paper product with both microembossments and macroembossments, whereby each ply is first separately microembossed, then joined, and then subsequently macroembossed together. This results in a product where each ply is both microembossed and macroembossed.

It has surprisingly been found that a multi-ply paper product with one or more improved attributes, including improved caliper, absorbency, stack height, and/or aesthetics, may be obtained whereby one ply is both microembossed and macroembossed and a second ply is only microembossed without being macroembossed. Optionally, each ply in the multi-ply paper product is subjected to only one embossing stage. Without wishing to be bound by theory, it is believed that a two-stage embossing process, such as that described in U.S. Pat. No. 7,799,169, whereby each ply is conveyed through two different embossing nips, may contribute to degradation of one or more of the above properties. In some embodiments, a one-stage embossing process that avoids a second stage may therefore be used to manufacture improved paper products according to the present disclosure.

### SUMMARY OF THE DISCLOSURE

Embossed multi-ply paper products are described herein comprising at least two cellulosic fibrous plies, wherein a first ply comprises an emboss pattern with both microembossments and macroembossments, wherein a second ply comprises an emboss pattern with only microembossments, and wherein the at least first and second plies are joined together at tips of the microembossments on the first ply to tips of the microembossments on the second ply. The multi-ply paper products may exhibit one or more of improved caliper, absorbency, stack height, and/or aesthetics as compared to products bearing only microembossments on both plies, only macroembossments on both plies, or both micro- and macroembossments on both plies.

Also described herein are methods for making a multi-ply paper product comprising; forming at least two cellulosic fibrous plies, conveying a first ply through a first emboss nip to emboss the first ply with an emboss pattern with both microembossments and macroembossments, conveying a second ply through a second emboss nip to emboss the second ply with an emboss pattern with only microembossments, and joining the at least two plies together at tips of the microembossments on the first ply to tips of the microembossments on the second ply.

In some embodiments, the tips of the microembossments on the first ply may be joined to the tips of the microembossments on the second ply by glue lamination, optionally wherein the glue is added to the tips of the microembossments on the second ply before joining, and optionally wherein the second ply comprises microembossments that substantially match with the pattern of microembossments on the first ply.

The multi-ply paper products disclosed herein may be napkins, paper towels, toilet tissues, facial tissues, wipers, hand towels, placemats, and the like. In some embodiments, the multi-ply paper products may be folded products, such as a napkin or facial tissue, wherein the first ply comprising both microembossments and macroembossments faces the outside of the folded product. In some embodiments, the multi-ply paper products may be rolled products, such as a paper towel or toilet tissue, wherein the first ply comprising both microembossments and macroembossments faces the outside of the rolled product.

### BRIEF DESCRIPTION OF THE DRAWINGS

FIG. 1A illustrates an exemplary emboss pattern according to one embodiment of the disclosure, including both microembossments and macroembossments.

FIG. 1B illustrates an enlarged cross section of a single macroemboss element of FIG. 1A.

FIG. 1C illustrates an enlarged cross section of microemboss elements of FIG. 1A.

FIG. 2 is an exemplary converting process according to the prior art with a two-stage embossing process, wherein both plies are embossed with both microembossments and macroembossments.

FIG. 3 illustrates an exemplary converting process according to one embodiment of the present disclosure with a single-stage emboss process wherein a first ply is embossed with both microembossments and macroembossments and a second ply is embossed with only microembossments.

FIG. 4 illustrates an exemplary emboss pattern according to one embodiment of the disclosure, including both microembossments and macroembossments, wherein the pattern is offset from the machine direction by 10°.

### DETAILED DESCRIPTION OF THE PREFERRED EMBODIMENTS

Reference will now be made in detail to certain exemplary embodiments, examples of which are illustrated in the accompanying drawings. Wherever possible, the same reference numbers will be used throughout the drawings to refer to the same or like items.

The present disclosure relates to multi-ply paper products comprising at least two cellulosic fibrous plies, wherein a first ply comprises an emboss pattern with both microembossments and macroembossments, wherein a second ply comprises an emboss pattern with only microembossments, and wherein the at least first and second plies are joined together at tips of the microembossments on the first ply to tips of the microembossments on the second ply. The phrase “emboss pattern with only microembossments” refers to an emboss pattern including only microembossments and not including macroembossments (though the ply may optionally contain other markings, printings, or the like, including coin edging).

The term “ply,” as used herein, refers to a monolithic or stratified fibrous structure that is integrally formed on a papermaking machine. The term “ply” may also be referred to as a “web,” “nascent web,” “tissue,” “sheet,” “base sheet,” or “tissue sheet,” which terms can be used interchangeably to refer to the ply during various stages of its development. Nascent web, for example, is often used to refer to the embryonic web that is deposited on the forming wire. Once the web achieves less than about 30% solids content, it is often referred to as a tissue or a sheet. Post-production, and prior to converting, the ply is often called a base sheet. A base sheet may be combined with other base sheets to form a multi-ply paper product.

The fibrous plies for use in the products of the present disclosure may be made from any art-recognized fibers. Papermaking fibers used to form the absorbent products of the present disclosure include cellulosic fibers, commonly referred to as wood fibers.

Specifically, the base sheet of the disclosure can be produced from hardwood (angiosperms or deciduous trees) or softwood (gymnosperms or coniferous trees) fibers, and any combination thereof. Hardwood fibers include, but are not limited to maple, birch, aspen and eucalyptus. Hardwood fibers generally have a fiber length of about 2.0 mm or less. Softwood fibers include, but are not limited to, spruce and pine. Softwood fibers exhibit an average fiber length of about 2.5 mm. Cellulosic fibers from diverse material origins may also be used to form the web of the present disclosure. The web of the present disclosure may also include recycled or secondary fiber. The products of the present disclosure can also include synthetic fibers as desired for the end product. The term “cellulosic fibrous ply” refers to a ply wherein the fibrous structure is predominantly derived from cellulosic fibers.

Cellulosic fibers can be liberated from their source material by any one of a number of chemical pulping processes familiar to one experienced in the art including sulfate, sulfite, polysulfite, soda pulping, etc. The pulp can be bleached as desired by chemical means including the use of chlorine, chlorine dioxide, oxygen, etc. Alternatively, the cellulosic fibers can be liberated from source material by any one of a number of mechanical/chemical pulping processes familiar to anyone experienced in the art including mechanical pulping, thermomechanical pulping, and chemi-thermomechanical pulping. These mechanical pulps can be bleached, if one wishes, by a number of familiar bleaching schemes including alkaline peroxide and ozone bleaching.

The plies may be manufactured on any type of papermaking machine. In general, the production of paper plies and products occurs by one of three methods: (1) conventional wet press (CWP) with wet creping and embossing, as described in U.S. Pat. No. 5,048,589 (incorporated herein by reference in its entirety); (2) CWP with dry creping and embossing, as also described in U.S. Pat. No. 5,048,589 (incorporated herein by reference in its entirety); and (3) through-air-drying (TAD) with or without creping, as described in U.S. Pat. Nos. 3,301,746 and 3,905,863 (both incorporated herein by reference in their entireties).

In a typical process to form a ply, fibers are fed into a headbox where they are admixed with water and chemical additives, as appropriate, before being deposited on a forming wire before most of the liquid is removed. The resulting fibrous ply derives some of its structural integrity from the geometric and mechanical arrangement of the cellulosic fibers in the web; however, most of the fibrous ply's strength is derived from hydrogen bonding that links the cellulosic fibers to one another. The degree of strength imparted by this inter-fiber bonding, while necessary to the utility of the product, may result in a lack of perceived softness that is inimical to consumer acceptance.

One method of increasing the perceived softness of a paper product is to crepe the paper. Creping may occur by affixing the cellulosic web to a Yankee dryer with an adhesive or adhesive/release agent combination and then scraping the web off the Yankee with a creping blade. By breaking a significant number of inter-fiber bonds, creping adds to and increases the perceived softness of the paper product. Creping, Yankee dryers, adhesive agents, release agents, and creping blades are described in more detail in U.S. Pat. Nos. 5,961,782, 6,207,011, and 6,663,942, each of which is incorporated herein by reference in their entireties.

In conventional wet pressing, the nascent web is transferred to a papermaking felt and is dewatered by passing it between the felt and a press roll under pressure. The web is then pressed by a suction press roll against the surface of a rotating Yankee dryer cylinder that is heated to cause the paper to substantially dry on the cylinder surface. The moisture within the web as it is laid on the Yankee surface causes the web to transfer to the surface. Liquid adhesive may be applied to the surface of the dryer, as necessary, to provide substantial adherence of the web to the surface. The web is then removed from the Yankee surface with a creping blade. The creped web may then be passed between calendar rollers and may be rolled up to be used as a base sheet in the downstream production of a paper product. This method of making tissue sheets is commonly referred to as “wet-pressed” because of the compactive method used to dewater the wet web.

In some embodiments, the fibrous webs of the present invention may be formed by a conventional wet press (CWP) process. While one conventional wet pressing operation is described above, the process is only exemplary and variations on the described process will be readily apparent to the skilled artisan.

In through-air-drying (“TAD”) methods, the nascent web is partially dewatered using vacuum suction. Thereafter, the partially dewatered web is dried without compression by passing hot air through the web while it is supported by a through-drying fabric. However, as compared to conventional wet pressing, through-air-drying is expensive in terms of capital and energy costs. Because of the consumer perceived softness of these products and their greater ability to absorb liquid than webs formed in conventional wet press processes, the products formed by the through-air-drying process enjoy an advantage in consumer acceptance. Because they do not suffer from compaction losses, through-air-dried tissue base sheets currently exhibit the highest caliper, i.e., bulk, of any base sheet for use in premium absorbent products.

Variations on TAD include processes that use special fabrics or belts to impart a structure to the sheet, but which continue to use some limited nip load. In connection with the production of structured sheets, fabric molding has also been employed as a means to provide texture and bulk. In this respect, there is seen in U.S. Pat. No. 6,610,173 to Lindsay et al. a method for imprinting a paper web during a wet pressing event which results in asymmetrical protrusions corresponding to the deflection conduits of a deflection member. The '173 patent reports that a differential velocity transfer during a pressing event serves to improve the molding and imprinting of a web with a deflection member. The tissue webs produced are reported as having particular sets of physical and geometrical properties, such as a pattern-densified network and a repeating pattern of protrusions having asymmetrical structures. With respect to wet-molding of a web using textured fabrics, see U.S. Pat. Nos. 6,017,417 and 5,672,248 both to Wendt et al.; 5,505,818 and 5,510,002 to Hermans et al. and U.S. Pat. No. 4,637,859 to Trokhan. With respect to the use of fabrics used to impart texture to a mostly dry sheet, see U.S. Pat. No. 6,585,855 to Drew et al., as well as U.S. Pat. No. 6,607,638.

As used herein, “structured tissues” or “structured webs” refer to tissue made by TAD or other structured tissue technologies. These processes all share the characteristic that the sheet is dewatered under limited or no compaction.

In some embodiments, the fibrous webs of the present invention may be formed by a TAD process. While some conventional through-air-drying operations are described above, the processes are only exemplary and variations on the described processes will be readily apparent to the skilled artisan.

Additives for use in the formation of the fibrous cellulosic base sheet plies can be any known combination of papermaking chemicals. Such chemistry is readily understood by the skilled artisan and its selection will depend upon the type of end product that one is making. Additives include, for example, one or more of creping modifiers, softeners and debonders, sizing agents, retention agents, strength agents, fillers, optical brightening agents, and the like.

In some embodiments, the multi-ply paper products as described herein comprise at least one ply comprising at least one chemical softening and/or debonding agent. Softening and/or debonding agents suitable for use include, but are not limited to, those belonging to the class of imidazolinium compounds prepared by reacting two fatty acids or esters with a polyalkylene polyamine, and then alkylating the product with an alkylating agent such as methyl sulfate.

In some embodiments, the multi-ply paper products as described herein comprise at least one ply comprising at least one sizing agent. Sizing agents suitable for use include, but are not limited to, reactive sizing agents (such as alkenyl ketene dimer (ALKD), alkyl ketene dimer (AKD), and alkenyl succinic anhydride (ASA)), fluorochemicals, silicones, hydrophobically modified anionic polymer (HMAP), hydrophobically modified cationic polymer (HMCP), ethylene-acrylic acid (EAA), neutral rosin emulsions, and conventional paper sizing agents.

In some embodiments, the multi-ply paper products as described herein comprise at least one ply comprising at least one retention aid. Retention aids suitable for use include, but are not limited to, polyamines, acrylamides, polyacrylamide, diallyl dimethyl ammonium chloride (DADMAC), polyethylenimines, and cationic coagulants.

In some embodiments, the multi-ply paper products as described herein comprise at least one ply comprising at least one wet strength additive. wet strength additives suitable for use include, but are not limited to, polyamide-epichlorohydrin (PAE) resins. One example of these resins is AMRES® 15 HP sold by Georgia-Pacific Corp. Two additional examples of these resins are Kymene® 557LX and Kymene® 557H sold by Hercules Inc. of Wilmington, Del. Such resins and the process of making the resins are described in U.S. Pat. Nos. 3,700,623 and 3,772,076, both of which are incorporated herein by reference in their entireties. Additional description of polyamide-epichlorohydrin resins is given in Espy, “Chapter 2: Alkaline-Curing Polymeric Amine-Epichlorohydrin Resins,” Wet Strength Resins and Their Application (L. Chan, ed., 1994). Further description and examples of polyamide-epichlorohydrin resins is given in Westfelt, Cellulose Chemistry and Technology, Vol. 13, p. 813 (1979).

In some embodiments, the at least one wet strength additive may be a temporary wet strength agent. Useful temporary wet strength agents include, but are not limited to, aliphatic and aromatic aldehydes including glyoxal, malonic dialdehyde, succinic dialdehyde, glutaraldehyde and dialdehyde starches, as well as substituted or reacted starches, disaccharides, polysaccharides, chitosan, or reacted polymeric reaction products of monomers or polymers having aldehyde groups, and optionally, amine groups.

In some embodiments, the multi-ply paper products as described herein comprise at least one ply comprising at least one dry strength agent. Useful dry strength agents suitable for use include, but are not limited to, starch, guar gum, polyacrylamides, and carboxymethyl cellulose.

In some embodiments, the multi-ply paper products as described herein comprise at least one ply comprising at least one particulate filler. Useful particulate fillers include, but are not limited to, clay, calcium carbonate, titanium dioxide, talc, aluminum silicate, silica, calcium silicate, calcium sulfate, as well as the “ash” normally occurring in recycled fibers.

In some embodiments, the multi-ply paper products as described herein comprise at least one ply comprising at least one other additive, including, but not limited to, sizing agents, absorbency aids, opacifiers, brighteners, optical whiteners, dyes, colorants, or starches.

The one or more additives may be introduced to the at least one ply at many or multiple points during the papermaking process. In some embodiments, one or more additives may be added to the stuffbox. In some embodiments, one or more additives may be added to the suction side of the machine chest pump. In some embodiments, one or more additives may be sprayed onto the web before the suction pressure roll. In some embodiments, one or more additives may be sprayed onto the ply before drying. In some embodiments, one or more additives may be added to the web during drying. In some embodiments, one or more additives may be sprayed onto the ply after drying. In some embodiments, additives may be added at many or multiple points during the papermaking process described above.

While exemplary formation of fibrous plies are detailed above, products using any fibrous plies can be used. The fibrous plies for use in the present disclosure can include those that are creped or uncreped, homogeneous or stratified, wet-laid or air-laid, and may contain up to 100% cellulose fibers.

In atypical process, after drying, the fibrous ply (base sheet) is rolled and awaits converting. While converting operations are generally carried out on rolled (reeled) paper plies, converting operations may also be added directly to the end of a papermaking process or processes without being rolled up first. Converting refers to the process that changes or converts base sheets into final products. Typical converting in the area of paper products according to the present disclosure may include calendaring, embossing, perforating, gluing, plying, slitting, rolling, and/or folding. The paper products disclosed herein may be subjected to any of the recognized converting operations that are readily apparent to the skilled artisan.

Embossing is the act of mechanically working a fibrous ply to cause the fibrous ply to conform under pressure to the depths and contours of a patterned embossing roll. In general, the ply is conveyed through an emboss nip between a pair of rolls (at least one of which is a pattern roll) that, under pressure, form embossments within the surface of the ply. Unless indicated otherwise, “an emboss, (the noun)”, “embossing element,” “embossment,” and “boss,” are all used herein interchangeably and refer to an element within an embossing pattern on a pattern roll that causes the base sheet to form protrusions or recessions in the fibrous ply, or to the protrusions or recessions in the plies themselves.

In most embossing configurations, at least one of the two roller surfaces directly carries the emboss pattern to be transferred to the paper web or ply and may be referred to as a pattern roll. In some configurations, the opposing roll may be known as a backing roll. In some embodiments, the backing roll may have a relatively smooth surface that does not form noticeable impressions on the fibrous ply.

Pattern rolls may be rigid rolls comprising either a steel body that is directly engraved or a hard rubber-coated surface such as with ebonite (either directly coated or sleeved) that is laser engraved. While a directly engraved steel roll has a longer lifespan, its production may require significant lead time. Laser engraved sleeved rolls may require less production lead time, but often have a lifespan substantially less than that of a steel roll. Backing rolls may be resilient rolls comprising a steel core directly coated or sleeved with a resilient material (such as a resilient rubber) and may or may not be engraved with a pattern. If a pattern is present, the pattern may be either a mated, matched-mated, or a non-mated pattern with respect to the pattern carried on the rigid pattern roll.

Known embossing configurations include rigid-to-resilient and rigid-to-rigid embossing. In a rigid-to-resilient embossing system, a single or multi-ply substrate is passed through a nip formed between a pattern roll, the substantially rigid surface of which contains the embossing pattern as a multiplicity of protuberances and/or depressions arranged into an aesthetically pleasing manner, and a backing roll, the substantially resilient surface of which may either be smooth or also contain a multiplicity of protuberances and/or depressions that cooperate with the rigid surfaced patterned roll.

In a rigid-to-rigid embossing system, a single-ply or multi-ply substrate is passed through a nip formed between two substantially rigid rolls. The surfaces of both rolls contain the pattern to be embossed as a multiplicity of protuberances and/or depressions arranged into an aesthetically pleasing manner. The protuberance and/or depressions of the second roll cooperate with those patterned in the first rigid roll. The first rigid roll is generally comprised of either a steel body that is directly engraved or a hard rubber-coated surface (either directly coated or sleeved) that is laser engraved. The second rigid roll generally comprises a steel body that is directly engraved or a hard rubber-covered surface (either directly coated or sleeved) possessing a matching or mated pattern that is either conventionally engraved or laser engraved.

Embossing patterns of the instant disclosure are made up of elements that may be arranged to create a design. The particular pattern may be chosen based on a myriad of considerations, including those that are functional as well as those that are non-functional, aesthetic and ornamental. Emboss patterns for use in the instant disclosure may be or contain an indication of source of the paper product or may be or contain one or more design elements that are trademarks or other source identifiers. In some embodiments, at least one ply may contain an emboss pattern that traverses the entire width and length of the at least one ply. In some embodiments, all plies of the multi-ply product may contain an emboss pattern that traverses the entire width and length of each respective ply.

According to the present invention a first ply of the multi-ply paper product comprises an emboss pattern with both microembossments and macroembossments and a second ply comprises an emboss pattern with only microembossments. As used herein, the term “microembossment” or “microemboss element” refers to a single emboss element having a base, one or more side walls, and an apex (also known as a tip), wherein no dimension of the base of the emboss element in the plane of the fibrous ply (or surface of the pattern roll) exceeds 2.5 millimeters, for example no dimension exceeds about 2 millimeters, about 1.5 millimeters, or about 1 millimeter. The microembossments according to the present invention may be of any shape, (for example, circular, oval, trapezoidal, square, and the like) so long as no dimension of the base of the microemboss element in the plane of the fibrous ply (or surface of the pattern roll) exceeds 2.5 millimeters. The height of the microemboss elements may be at least about 0.5 millimeters, for example at least about 1 millimeter, at least about 1.5 millimeters, at least about 2 millimeters, or at least about 2.5 millimeters.

In some embodiments, the microembossments may be arranged in a repeating pattern of a series microemboss elements. In some embodiments, the microemboss elements may be arranged in a pattern containing at least about 20 microemboss elements per square centimeter, for example at least about 30, at least about 40, at least about 60, at least about 80, or at least about 100 microemboss elements per square centimeter. In some embodiments, the microembossments may be arranged in a uniform pattern. In some embodiments, the microembossments may be arranged to form the impression of larger patterns such as circles, ovals, diamonds, and the like.

As used herein, the term “macroembossment” or “macroemboss element” refers to a single emboss element having a base, at least one sidewall, and an apex, wherein the base of the emboss element has at least one dimension in the plane of the fibrous ply (or surface of the pattern roll) that exceeds 2.5 millimeters, for example at least one dimension that exceeds about 5 millimeters, about 7.5 millimeters, about 10 millimeters, about 15 millimeters, or about 20 millimeters. The macroembossments according to the present invention may be of any shape, so long as the base of the macroemboss element has at least one dimension in the plane of the fibrous ply (or surface of the pattern roll) that exceeds 2.5 millimeters. For example, typical macroemboss elements may be emboss elements having a recognizable shape, such as hearts, flowers, wavy lines, and the like. In some embodiments, the macroemboss elements may be continuous elements, such as circles, diamonds, and the like. As used herein “continuous element” refers to an element that is a closed loop. The loop may be any shape or design. In some embodiments, macroemboss elements according to the present invention may be elements wherein the base of the elements in the plane of the fibrous ply have a width of less than 2.5 millimeters, but a length that exceeds 2.5 millimeters. The height of the macroemboss elements may be at least about 0.5 millimeters, for example at least about 1 millimeter, at least about 2 millimeters, at least about 3 millimeters, or at least about 4 millimeters.

In some embodiments, the macroembossments may be arranged in a repeating pattern of a series macroemboss elements. In some embodiments, the repeating series of macroemboss elements may be aligned in the machine direction (the direction parallel to the direction of the movement of the ply when formed on the forming wire of a papermaking machine). In some embodiments, the repeating series of macroemboss elements may be offset from the machine direction by at least about 5°, at least about 10°, at least about 20°, at least about 30°, or at least about 45°.

In some embodiments where a fibrous ply (or pattern emboss roll) has both microemboss elements and macroemboss elements, the microemboss elements may be located in the negative spaces between the macroemboss elements such that the microemboss elements and the macroemboss elements do not overlap. In some embodiments, the microembossments on the first ply (comprising both microembossments and macroembossments) may be arranged in the negative spaces between the macroemboss elements. In some embodiments, the first ply (or pattern emboss roll) may comprise microemboss elements that are arranged in the interior of continuous macroemboss elements. In some embodiments, the first ply (or pattern emboss roll) may comprise microemboss elements that are in the interior of continuous macroemboss elements and arranged symmetrically about the center of the continuous macroemboss elements.

In some embodiments, the microembossments on the second ply (comprising only microembossments) may be arranged in substantially the same pattern as the microembossments on the first ply such that the second ply has negative spaces in the microemboss pattern corresponding to where the macroembossments are located on the first ply. In some embodiments, the microembossments on the second ply (comprising only microembossments) may be arranged in a uniform pattern across the entire length and width of the second ply, comprising microembossments that substantially match the pattern of microembossments on the first ply but also comprising microembossments in the spaces corresponding to where the macroembossments are located on the first ply. In that configuration, the tips of some of the microembossments on the second ply may join to portions of the apexes of the macroembossments on the first ply. In either of those two configurations, the microembossments on the second ply (comprising only microembossments) may be said to be arranged in a pattern that substantially matches the pattern of microembossments on the first ply.

One embodiment of the present disclosure relates to novel embossing rolls having a pattern of both microemboss elements and macroemboss elements as described herein.

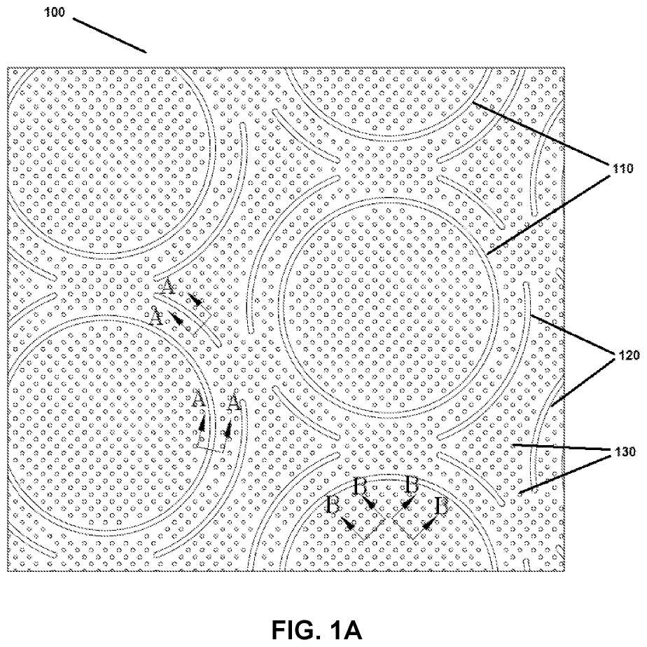

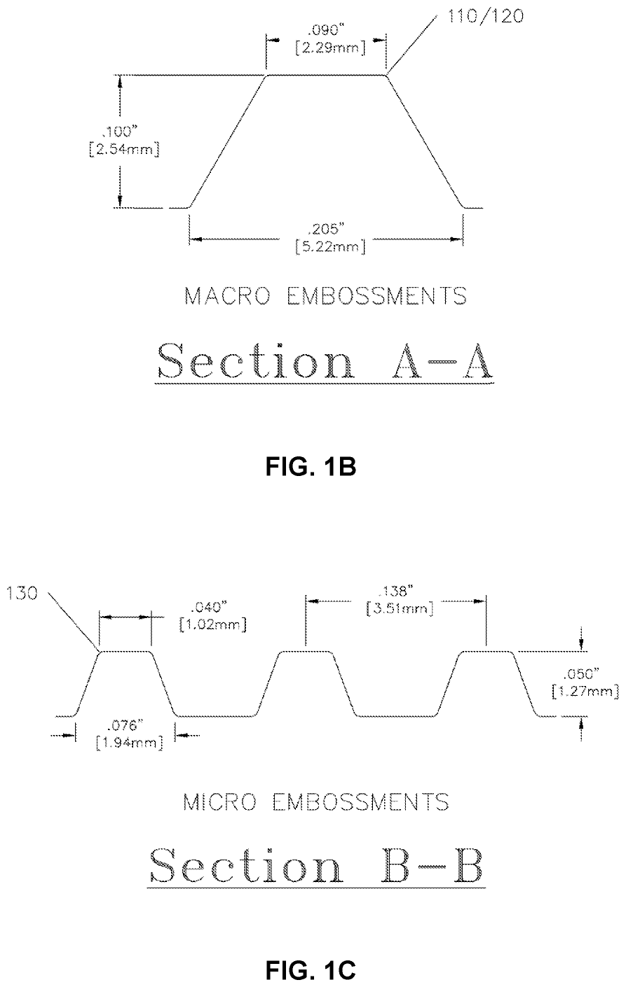

FIG. 1A shows an exemplary emboss pattern 100 according to the present invention having continuous circular-shaped macroemboss elements 110, non-continuous circular-shaped macroemboss elements 120, and dot-shaped microemboss elements 130. FIG. 1B shows a cross section of macroemboss elements 110/120 along the line A-A in FIG. 1A (showing the width and height of element 110/120). The lengths of the macroemboss elements 110/120 are not shown in FIG. 1B, but exceed 2.5 millimeters. FIG. 1C shows a cross section of three microemboss elements 130 along the line B-B in FIG. 1A (showing the width and height of elements 130). The lengths of the microemboss elements 130 are not shown in FIG. 1C, but do not exceed 2.5 millimeters. The macroemboss elements in the example in FIG. 1A are aligned in the machine direction. The pattern of microemboss elements in FIG. 1A are arranged in a pattern containing 50 microemboss elements per square centimeter.

In some embodiments, the fibrous plies may also be coin edged. Coin edging is generally used for plying the edges of a multi-ply paper product, although it may also be used to impart an aesthetic design and/or to increase bulk. In some embodiments, the multi-ply paper products of the present invention comprise a first ply which comprises an emboss pattern with both microembossments and macroembossments, a second ply which comprises an emboss pattern with only microembossments, and wherein the at least first and second plies each further comprise coin edging.

Plying, or ply bonding, is the act of joining two or more substrates. When the plies of the paper product are produced separately, the plies are plied together to form the paper product. Plying may be accomplished by several different techniques. In some embodiments, plying involves the mechanical ply bonding of the plies. In some embodiments, plying involves joining the plies together with glue. In some embodiments, plying involves glue-laminating the plies together. In some embodiments, plying involves hot melt gluing the plies together. In some embodiments, plying involves emboss ply bonding the plies together.

In some embodiments, the at least two cellulosic fibrous plies may be joined together in a tip-to-flat configuration, wherein the tips of embossments on the first ply are bonded to flat portions of the second ply (or vice versa). In some embodiments, the at least two cellulosic fibrous plies may be joined together in a tip-to-tip configuration, wherein tips of the microembossments on the first ply are joined to tips of the microembossments on the second ply. In some embodiments, the at least two cellulosic fibrous plies may be joined together at tips of the microembossments on the first ply to tips of the microembossments on the second ply, wherein the Yankee or smoother sides of the at least two plies faces the outside of the product.

In some embodiments, the at least two cellulosic fibrous plies may be joined together at tips of the microembossments on the first ply to tips of the microembossments on the second ply by glue lamination. Glue (adhesive) may be applied by several different techniques. In some embodiments, the glue for plying by glue lamination is rolled onto one ply before joining with another ply. In some embodiments, the glue for plying by glue lamination is rolled onto the tips of the microembossments of the first ply before joining with the second ply. In some embodiments, the glue for plying by glue lamination is rolled onto the tips of the microembossments of the second ply before joining with the first ply. In some embodiments, the glue for plying by glue lamination is rolled onto the tips of the microembossments of both the first and the second ply before joining the two plies together.

The glue used for glue lamination may be any of those known to one of ordinary skill in the art. In one embodiment, the glue is a water-based synthetic resin. In another embodiment, the solids in the glue comprise more than 50% of a polyvinyl alcohol. In a further embodiment, the glue may comprise a polyamide-epichlorohydrin (PAE) resin. Two examples of glue are WB-2775M and WB-2746 manufactured by the H.B. Fuller Company of St. Paul, Minn.

In some embodiments, following joinder of the plies, the converting process may comprise a slitter apparatus to cut the multi-ply paper product into multiple sheets.

In some embodiments, following slitting of the multi-ply paper product, the converting process may comprise a rolling apparatus, if the paper products to be made require rolling before packaging and/or shipment. This may be the case, for example, in the manufacture of rolled paper towel or toilet tissue products. In some embodiments, the multi-ply paper products are rolled such that the first ply (bearing both microembossments and macroembossments) faces the outside of the rolled product, for example a rolled paper towel or toilet tissue product.

In some embodiments, following slitting of the multi-ply paper product, the converting process may comprise a folder apparatus, if the paper products to be made require folding before packaging and/or shipment. This may be the case, for example, in the manufacture of folded napkin or facial tissue products. Folding may be carried out by an apparatus manufactured by, for example, C.G. Bretting Manufacturing Co., Inc. In some embodiments, the multi-ply paper products are folded such that the first ply (bearing both microembossments and macroembossments) faces the outside of the folded product, for example a napkin or facial tissue product.

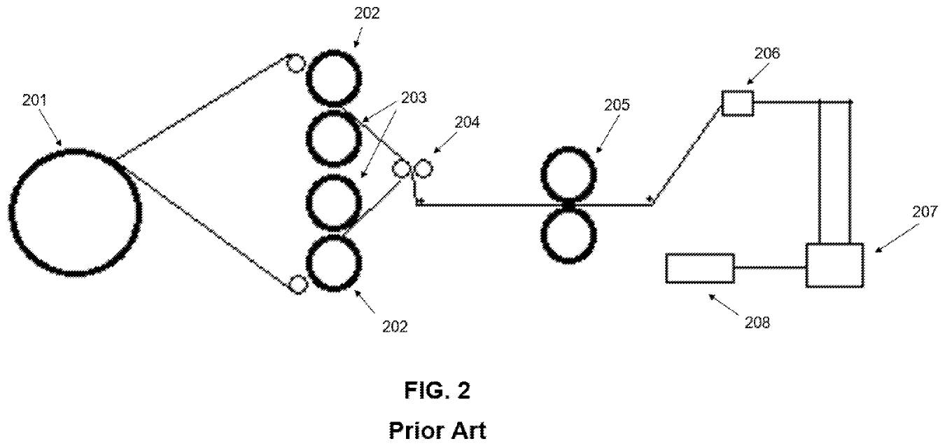

FIG. 2 depicts a converting method having a prior art two-stage embossing process, such as that described in U.S. Pat. No. 7,799,169. Two cellulosic fibrous plies are pre-calendered and unrolled from roll 201. Each of the plies is passed through an embossing nip between a backing roll 202 and a pattern roll 203. Pattern roll 203 is engraved with an emboss pattern with only microemboss elements and thus imparts an emboss pattern to each of the two plies with only microembossments. The microembossed plies are then passed through plying station 204 that glue laminates and joins the two plies together. The joined, glue laminated plies are then carried to the macroembossing station 205 that imparts a macroemboss pattern to the two joined plies. The macroembossed plies are then passed through a slitter assembly 206 to create two strips. The two strips are then introduced into the folder 207 that creates finished napkin products 208. The multi-ply products formed by the converting process of FIG. 2 thus comprise both microembossments and macroembossments on all plies.

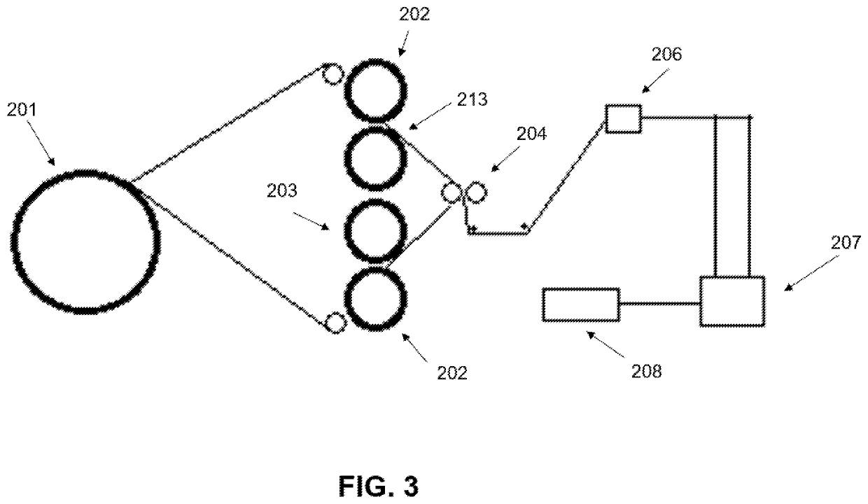

FIG. 3 reveals one embodiment of a converting process that may be used to produce a multi-ply paper product in accordance with one embodiment of this description. The skilled artisan would be aware of alternative converting processes that could also be used within the scope of the broader product and methods described herein. In the converting process exemplified in FIG. 3, two cellulosic fibrous plies are pre-calendered and unrolled from roll 201. Each of the plies is passed through an embossing nip. A first ply is passed between backing roll 202 (which may be a resilient backing roll) and a pattern roll 213 (which may be a rigid, steel pattern roll). Pattern roll 213 is engraved with an emboss pattern with both microemboss elements and macroemboss elements and thus imparts an emboss pattern to the first ply with both microembossments and macroembossments. The second ply is passed between backing roll 202 (which may be a resilient backing roll) and a pattern roll 203 (which may be a rigid, steel pattern roll). Pattern roll 203 is engraved with an emboss pattern with only microemboss elements and thus imparts an emboss pattern to the second ply with only microembossments. The plies are then passed through plying station 204 that joins the two plies together.

In some embodiments, glue may be applied to the first ply before being joined with the second ply. In some embodiments, glue may be applied to the second ply before being joined with the first ply. In some embodiments, the first and second plies may be joined together at the tips of the microembossments on the first ply to the tips of the microembossments on the second ply. In some embodiments, glue may be applied to tips of the microembossments on the second ply before being joined with the first ply, and the first and second plies may be joined together at the tips of the microembossments on the first ply to the tips of the microembossments on the second ply by glue lamination.

As shown in FIG. 3, following embossment, the plies may be passed through a separate plying station 204 that joins the two plies together. Alternatively, in some embodiments, the first ply and the second ply may be joined together as they pass in a nip between the first pattern roll and the second pattern roll, without need for a separate plying station 204. Alternatively, in some embodiments, the first ply and the second ply may be joined in a nip formed between a separate marrying roll matched with either the first pattern roll or the second pattern roll.

Continuing in FIG. 3, the joined, glue laminated product is then passed through a slitter assembly 206 to create two strips. The two strips are then introduced into the folder 207 that creates finished folded products 208.

Without wishing to be bound by theory, it is believed that a two-stage embossing process, such as that depicted in FIG. 2, whereby each ply is conveyed through two different embossing nips, may contribute to degradation of one or more attributes of the final product, for example, caliper, absorbency, strength, and/or aesthetics. The present inventors surprisingly discovered that, by conveying a first ply through a first emboss nip to emboss the first ply with an emboss pattern with both microembossments and macroembossments and conveying a second ply through a second emboss nip to emboss the second ply with an emboss pattern with only microembossments, without either ply being subjected to a second embossing nip thereafter as depicted for example in FIG. 3, one or more of caliper, absorbency, strength, and/or aesthetics of the final product may be improved.

While macroembossments are often aesthetically pleasing, the application of macroembossments may undesirably result in decreased strength of the resultant macroembossed ply. Without wishing to be bound by theory, it is believed that having at least one ply with only microembossments results in a stronger multi-ply product than a product wherein each ply has macroembossments. In addition, the cost and operation for producing a multi-ply product, as well as ease of changing the emboss pattern, may be desirably improved where at least one of the plies is embossed only with microembossments instead of both microembossments and macroembossments.

Elimination of a second embossing stage, such as that depicted in FIG. 2, also beneficially results in simplification of the converting process, thus reducing operating costs, maintenance, and down time. It is believed that the improved properties of the resultant product according to the example depicted in FIG. 3, such as improved caliper, also leads to better folder and/or wrapper runnability when creating a stacked, folded product, such as a pack of napkins.

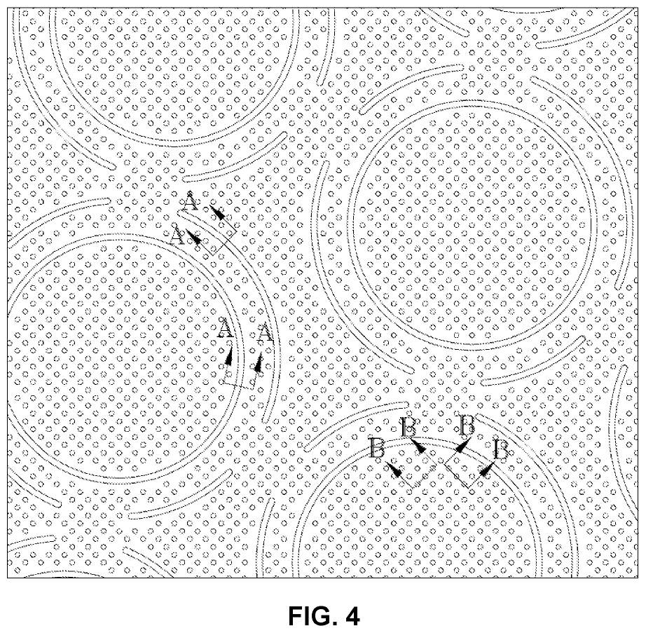

FIG. 4 illustrates an exemplary emboss pattern according to one embodiment of the disclosure, including both microembossments and macroembossments, wherein the pattern is offset from the machine direction by 10°. Without wishing to be bound by theory, it is believed that offsetting the macroembossment pattern from the machine direction increases the performance and longevity of the mating backing roll and reduces cyclic vibration of the emboss process.

In some embodiments, the multi-ply paper product may be a napkin product. In some embodiments, the multi-ply paper product may be a paper towel product. In some embodiments, the multi-ply paper product may be a toilet tissue product. In some embodiments, the multi-ply paper product may be a facial tissue product. In some embodiments, the multi-ply paper product may be a wiper product. In some embodiments, the multi-ply paper product may be a placemat product.

In some embodiments, the multi-ply paper product may be a folded product. In some embodiments, the multi-ply paper product may be a folded napkin product. In some embodiments, the multi-ply paper product may be a folded facial tissue product.

In some embodiments, the multi-ply paper product may be a rolled product. In some embodiments, the multi-ply paper product may be a rolled paper towel product. In some embodiments, the multi-ply paper product may be a rolled toilet tissue product.

The multi-ply paper products according to the present disclosure may have varying attributes, depending on the type of final product being produced. Nevertheless, it is believed that the multi-ply paper products according to the present disclosure will exhibit at least one of improved caliper, absorbency, strength, and/or aesthetics when compared to a similar product made with the same cellulosic fibrous ply base sheets, but with a two-stage embossing process as is depicted, for example, in FIG. 2.

In some embodiments, the multi-ply paper product, such as a two ply product, may have a total basis weight of from about 5 to about 40 lbs/ream, for example, from about 5 to about 15 lbs/ream, from about 25 to about 40 lbs/ream, from about 15 to about 25 lbs/ream, or from about 18 to about 23 lbs/ream. Unless otherwise specified, “basis weight”, “BWT,” “BW,” and so forth, refers to the weight of a 3000 square-foot ream of product. The basis weight may be measured under standard lab conditions (condition and test samples in an atmosphere of 23.0+/−1.0° C. (73.4+/−1.8° F.), 50% +/−2% R.H).

In some embodiments, the multi-ply paper product may have a caliper of from at least about 60 mils/8 sheets to about 300 mils/8 sheets, for example, from about 60 mils/8 sheets to about 100 mils/8 sheets, from about 90 mils/8 sheets to about 200 mils/8 sheets, from about 105 mils/8 sheets to about 130 mils/8 sheets, or from about 110 mils/8 sheets to about 125 mils/8 sheets. Unless otherwise specified, caliper may be measured at 8 sheets as follows. The sheets are stacked, and the caliper measurement taken about the central portion of the stack. Preferably, the test samples are conditioned in an atmosphere of 23°±1.0° C. (73.4°±1.8° F.) at 50% relative humidity for at least about 2 hours and then measured with a Thwing-Albert Model 89-II-JR or Progage Electronic Thickness Tester with 2-in diameter anvils, 539±10 grams dead weight load, and 0.231 in/sec descent rate. For finished multi-ply product testing, each sheet of product to be tested must have the same number of plies as the product as sold. For testing in general, eight sheets are selected and stacked together. For rolled or folded product testing, the product should be unwound or unfolded prior to stacking.

In some embodiments, the multi-ply paper product may have a SAT capacity (also known as water absorption capacity) of from about 300 to about 800 g/m², for example, from about 300 to about 400 g/m², from about 400 to about 600 g/m², or from about 450 to about 550 g/m². Unless otherwise specified, SAT capacity may be measured with a simple absorbency tester. The simple absorbency tester is a particularly useful apparatus for measuring the hydrophilicity and absorbency properties of a sample of tissue, napkins, towel, and the like. In this test, a sample of the product (e.g., tissue, napkins, or towel) 2.0 inches in diameter is mounted between a top flat plastic cover and a bottom grooved sample plate. In the case of a folded napkin, the sample consists of two layers of the multi-ply paper (for example, in the case of a quarter-fold napkin, the napkin is unfolded in half and a sample consisting of the half unfolded napkin is taken, which consists of two layers of the multi-ply product. The product sample disc is held in place by a ⅛ inch wide circumference flange area. The sample is not compressed by the holder. De-ionized water at 73° F. is introduced to the sample at the center of the bottom sample plate through a 1 mm diameter conduit. This water is at a hydrostatic head of minus 5 mm. Flow is initiated by a pulse introduced at the start of the measurement by the instrument mechanism. Water is thus imbibed by the tissue, napkin, or towel sample from this central entrance point radially outward by capillary action. When the rate of water imbibition decreases below 0.005 gm water per 5 seconds, the test is terminated. The amount of water removed from the reservoir and absorbed by the sample is weighed and reported as grams of water per square meter of sample or grams of water per gram of sheet.

In practice, an M/K Systems Inc. Gravimetric Absorbency Testing System is used. This is a commercial system obtainable from M/K Systems Inc., 12 Garden Street, Danvers, Mass., 01923. SAT capacity (also referred to as water absorbent capacity or WAC) is actually determined by the instrument itself. WAC is defined as the point where the weight versus time graph has a “zero” slope, i.e., the sample has stopped absorbing. The termination criteria for a test are expressed in maximum change in water weight absorbed over a fixed time period. This is basically an estimate of zero slope on the weight versus time graph. The program uses a change of 0.005 g over a 5 second time interval as termination criteria; unless “Slow SAT” is specified in which case the cut off criteria is 1 mg in 20 seconds.

Dry tensile strengths (MD and CD), wet tensile strengths (MD and CD), stretches (MD and CD), and ratios thereof may be measured with a standard Instron test device or other suitable elongation tensile tester, which may be configured in various ways, typically, using 3 inch or 1 inch wide strips of tissue or towel, conditioned in an atmosphere of 23°±1° C. (73.4°±1° F.) at 50% relative humidity for 2 hours. The tensile test is run at a crosshead speed of 2.0 in/min. For purposes of calculating modulus values, inch wide specimens were pulled at 0.5 inches per minute so that a larger number of data points were available. Unless otherwise clear from the context, stretch refers to stretch (elongation) at break. Break modulus is the ratio of peak load to stretch at peak load. Tensile modulus, reported in grams per inch per percent strain, is determined by the same procedure used for tensile strength except that the modulus recorded is the geometric mean of the chord slopes of the cross direction and machine direction load-strain curves from a value of 0 to 100 grams, and a sample width of only one inch is used.

In some embodiments, the multi-ply paper product may have a MD tensile strength of from about 200 g/3 in to about 5000 g/3 in, for example, from about 200 g/3 in to about 1000 g/3 in, from about 600 g/3 in to about 800 g/3 in, from about 1000 g/3 in to about 1500 g/3 in, from about 1500 g/3 in to about 3000 g/3 in, or from about 1800 g/3 in to about 2500 g/3 in.

In some embodiments, the multi-ply paper product may have a CD tensile strength of from about 200 g/3 in to about 5000 g/3 in, for example, from about 200 g/3 in to about 450 g/3 in, from about 450 g/3 in to about 1000 g/3 in, from about 1000 g/3 in to about 5000 g/3 in, or from about 1500 g/3 in to about 3500 g/3 in.

In some embodiments, the multi-ply paper product may have a wet CD tensile strength of from about 5 g/3 in to about 1500 g/3 in, for example, from about 10 g/3 in to about 100 g/3 in, from about 100 g/3 in to about 200 g/3 in, from about 200 g/3 in to about 1000 g/3 in, or from about 1000 g/3 in to about 1500 g/3 in.

In some embodiments, the multi-ply paper product may have a MD stretch of from about 5% to about 30%, for example, from about 10% oto about 15%, or from about 15% to about 20%.

In some embodiments, the multi-ply paper product may have a CD stretch of from about 2% to about 20%, for example, from about 5% to about 10%, or from about 10% to about 20%.

The following examples provide representative multi-ply napkin paper products according to the present disclosure. The methods and products described herein should not be limited to the examples provided. Rather, the examples are only representative in nature.

It is further to be understood that the preceding description is exemplary and explanatory only and not restrictive of the invention, as claimed. The accompanying drawings, which are incorporated in and constitute a part of this specification, illustrate embodiments and together with the description, serve to explain the principles of the disclosure

### Example 1

A trial was run comparing two-ply napkin products made according to the “standard” method of the prior art (with each ply being separately microembossed, before being joined and microembossed together) with two-ply napkin products made according to the present invention (with a first ply being embossed with a pattern with both microembossments and macroembossments and a second ply being embossed with a pattern with only microembossments). In both cases, the plies were joined together at the tips of the microembossments in a tip-to-tip configuration by applying glue to the tips of the microembossments on the second ply before joining. Napkin products of 12.90 inch length by 12.80 inch width were formed and packaged into packs with 80 napkins per package.

An initial run was first conducted, wherein the average attributes of the individual base sheet plies are shown below:

TABLE 1

| | | | | | | | Tensile | | |
|---|---|---|---|---|---|---|---|---|---|
| | | Caliper | Dry | | Stretch | | CD | | Wet |
| Basis | | after | Tensile | | MD | Tensile | Wet/Dry | Tensile | Tensile |
| Weight | Caliper | winder | Ratio | Stretch | after | CD | Ratio | MD | CD |
| (lbs/ | (mils/8 | (mils/8 | (g/3 | MD | winder | (g/3 | (g/3 | (g/3 | (g/3 |
| ream) | sheet) | sheet) | in) | (%) | (%) | in) | in) | in) | in) |
| 11.0 | 68.3 | 61.0 | 1.7 | 17.2 | 13.7 | 527.3 | 0.2 | 912.3 | 123.0 |

The average attributes of the resultant two-ply napkin products from the initial run are shown below:

TABLE 2

| | | | | | | | | Wet |
|---|---|---|---|---|---|---|---|---|
| | Caliper 8- | | Stack | | | Tensile | Tensile | Tensile |
| | Sheet | SAT | Height | Stretch | Stretch | CD | MD | CD |
| | (mils/8 | (gms/ | (in/80 | CD | MD | (g/3 | (g/3 | (g/3 |
| | sheet) | m²) | sheets) | (%) | (%) | in) | in) | in) |
| Standard | 108.2 | 450.3 | 5.1 | 7.9 | 22.9 | 952.2 | 1980.2 | 163.1 |
| Inventive | 109.7 | 461.7 | 5.3 | 7.8 | 13.6 | 983.1 | 1966.9 | 169.3 |

Having determined that the base sheets used in the first run were of inferior quality (at least in terms of formation and caliper after the winder), a second run was then conducted with base sheets having improved quality, wherein the average attributes of the individual base sheet plies are shown below:

TABLE 3

| | | | | | | | Tensile | | |
|---|---|---|---|---|---|---|---|---|---|
| | | Caliper | Dry | | Stretch | | CD | | Wet |
| Basis | | after | Tensile | | MD | Tensile | Wet/Dry | Tensile | Tensile |
| Weight | Caliper | winder | Ratio | Stretch | after | CD | Ratio | MD | CD |
| (lbs/ | (mils/8 | (mils/8 | (g/3 | MD | winder | (g/3 | (g/3 | (g/3 | (g/3 |
| ream) | sheet) | sheet) | in) | (%) | (%) | in) | in) | in) | in) |
| 11.0 | 74.2 | 65.6 | 1.8 | 16.8 | 14.2 | 518.3 | 0.2 | 944.8 | 121.0 |

The average attributes of the resultant two-ply napkin products from the second run are shown below:

TABLE 4

| | | | | | | | | Wet |
|---|---|---|---|---|---|---|---|---|
| | Caliper 8- | | Stack | | | Tensile | Tensile | Tensile |
| | Sheet | SAT | Height | Stretch | Stretch | CD | MD | CD |
| | (mils/8 | (gms/ | (in/80 | CD | MD | (g/3 | (g/3 | (g/3 |
| | sheet) | m²) | sheets) | (%) | (%) | in) | in) | in) |
| Standard | 104.1 | 431.6 | 5.0 | 7.9 | 11.4 | 784.3 | 1820.2 | 133.5 |
| Inventive | 112.5 | 466.0 | 5.3 | 8.3 | 11.9 | 751.5 | 1672.5 | 131.0 |

As can be seen from the table above, following the second run, the two-ply napkin products made according to the inventive process outperformed those made by the standard process in at least three physical attributes: caliper (112.5 vs 104.1), SAT (466.0 vs 431.6), and stack height (5.3 vs 5.0).

### Example 2

An additional trial was later run according to the present invention (with a first ply being embossed with a pattern with both microembossments and macroembossments and a second ply being embossed with a pattern with only microembossments). The plies were again joined together at the tips of the microembossments in a tip-to-tip configuration by applying glue to the tips of the microembossments on the second ply before joining. Napkin products with an average of 12.81 inches in length by 13.0 inches in width were formed and packaged into packs with 80 napkins per package.

The average attributes of the individual base sheet plies used in this example are shown below:

TABLE 5

| | | | | | | Tensile | | |
|---|---|---|---|---|---|---|---|---|
| | | Caliper | | Stretch | | CD | | Wet |
| Basis | | after | | MD | Tensile | Wet/Dry | Tensile | Tensile |
| Weight | Caliper | winder | Stretch | after | CD | Ratio | MD | CD |
| (lbs/ | (mils/8 | (mils/8 | MD | winder | (g/3 | (g/3 | (g/3 | (g/3 |
| ream) | sheet) | sheet) | (%) | (%) | in) | in) | in) | in) |
| 11.4 | 67.47 | 67.1 | 17.8 | 15.4 | 453.8 | 0.3 | 990.1 | 118.2 |

The average attributes of the resultant two-ply napkin products are shown below:

TABLE 6

| Basis | | | | | | | Wet |
|---|---|---|---|---|---|---|---|
| Weight | Caliper | | Stack | | Tensile | Tensile | Tensile |
| (lbs/ | 8-Sheet | SAT | Height | Stretch | CD | MD | CD |
| 3000 | (mils/8 | (gms/ | (in/80 | MD | (g/3 | (g/3 | (g/3 |
| ft²) | sheet) | m²) | sheets) | (%) | in) | in) | in) |
| 20.8 | 119.2 | 487.0 | 5.6 | 12.9 | 908.0 | 2353.0 | 198.0 |

1. A multi-ply paper product comprising,
at least two cellulosic fibrous plies,
wherein a first ply comprises an emboss pattern with both microembossments and macroembossments,
wherein a second ply comprises an emboss pattern with only microembossments, and
wherein the first ply and the second ply are joined together at tips of the microembossments on the first ply to tips of the microembossments on the second ply.

2. The multi-ply paper product of claim 1, wherein the second ply comprises a pattern of microembossments that substantially matches the pattern of microembossments on the first ply.

3. The multi-ply paper product of claim 1, wherein the first and second plies are joined together at the tips of the microembossments on the first ply to the tips of the microembossments on the second ply by glue lamination.

4. The multi-ply paper product of claim 1, wherein the product is a two-ply product.

5. The multi-ply paper product of claim 1, wherein the microembossments on the first ply are located in the negative spaces between the macroembossments on the first ply such that the microembossments and the macroembossments on the first ply do not overlap

6. The multi-ply paper product of claim 5, wherein the first ply comprises at least one continuous macroembossment with microembossments located in the interior of the at least one continuous macroembossment.

7. The multi-ply paper product of claim 1, wherein the first ply comprises a pattern of macroembossments that is offset from the machine direction by at least about 50.

8. The multi-ply paper product of claim 1, wherein the product is one of a napkin, paper towel, facial tissue, or toilet tissue.

9. The multi-ply paper product of claim 1, wherein the product is a rolled product and wherein the first ply faces the outside of the rolled product.

10. The multi-ply paper product of claim 9, wherein the product is a rolled paper towel or rolled toilet tissue product.

11. The multi-ply paper product of claim 1, wherein the product is a folded product and wherein the first ply faces the outside of the folded product.

12. The multi-ply paper product of claim 1, wherein the product is a folded napkin product.

13. The multi-ply paper product of claim 11, wherein the product is a folded napkin product.

14. The multi-ply paper product of claim 1, wherein the basis weight of the product is from about 15 to about 25 lbs/ream.

15. The multi-ply paper product of claim 1, wherein the caliper of the product is from about 90 mils/8 sheets to about 200 mils/8 sheets.

16. The multi-ply paper product of claim 1, wherein the caliper of the product is from about 110 mils/8 sheets to about 125 mils/8 sheets.

17. The multi-ply paper product of claim 1, wherein the product has an SAT capacity of from about 400 to about 600 g/m².

18. The multi-ply paper product of claim 1, wherein the product has an SAT capacity of from about 450 to about 550 g/m²

19. The multi-ply paper product of claim 1, wherein the product has an MD tensile strength of from about 1500 g/3 in to about 3000 g/3 in.

20. The multi-ply paper product of claim 1, wherein the product is a folded napkin product, wherein the basis weight of the product is from about 15 to about 25 lbs/ream, wherein the caliper of the product is from about 110 mils/8 sheets to about 125 mils/8 sheets, wherein the product has an SAT capacity of from about 450 to about 550 g/m2, and wherein the product has an MD tensile strength of from about 1500 g/3 in to about 3000 g/3 in.

21-36. (canceled)
